(19) United States
(12) Patent Application Publication
(10) Pub. No.: US 2025/0156881 A1
(43) Pub. Date: May 15, 2025

(54) MERCHANT AUTHENTICITY VERIFICATION SYSTEM AND METHOD BASED ON STREET VIEW IMAGE RECOGNITION

(71) Applicant: CHINA UNIONPAY CO., LTD., Shanghai (CN)

(72) Inventors: Zhijun Fei, Shanghai (CN); Yanming Yang, Shanghai (CN); Xuetao Qiu, Shanghai (CN); Pengfei Gao, Shanghai (CN)

(21) Appl. No.: 18/838,663

(22) PCT Filed: Aug. 19, 2022
(86) PCT No.: PCT/CN2022/113608

§ 371 Date: Aug. 15, 2024

(30) Foreign Application Priority Data
Feb. 17, 2022 (CN) 202210148355.X

(51) Int. Cl. G06Q 30/018; G06V 10/46

(52) U.S. Cl. CPC G06Q 30/018; G06V 10/462

(57) ABSTRACT

The present disclosure relates to a merchant authenticity verification system and method. The system comprises: a street view roaming module that calculates a translation scale for translating coordinates of an image acquisition point, calculates the coordinates of the image acquisition point based on the translation scale, and interacts with the street view image system to obtain a corresponding street view image based on the coordinates of the image acquisition point; an image comparison module that matches the merchant storefront image obtained with the street view image obtained from the street view roaming module to calculate merchant image similarity; a character recognition module for recognizing a merchant name from the street view image obtained from the street view roaming module; and a text comparison module for matching the merchant name recognized with the merchant name obtained from the merchant information platform to calculate merchant name similarity, and determining whether the merchant name similarity reaches a specified threshold, where in the case that the merchant name similarity reaches the specified threshold, merchant authenticity verification is successful. According to the present disclosure, the accuracy of merchant verification can be improved.

### CROSS-REFERENCE TO RELATED APPLICATIONS

The present application is a U.S. national stage application of International Application No. PCT/CN2022/113608, titled “MERCHANT AUTHENTICITY VERIFICATION SYSTEM AND METHOD BASED ON STREET VIEW IMAGE RECOGNITION,” filed on Aug. 19, 2022, and claims priority to Chinese Patent Application CN202210148355.X, titled “MERCHANT AUTHENTICITY VERIFICATION SYSTEM AND METHOD BASED ON STREET VIEW IMAGE RECOGNITION,” filed on Feb. 17, 2022, the disclosures of which are incorporated herein by reference in their entirety for all purposes.

### TECHNICAL FIELD

The present disclosure relates to computer technologies and, more specifically, to a merchant authenticity verification system based on street view image recognition and a merchant authenticity verification method based on street view image recognition.

### BACKGROUND

To obtain authentic merchant information, the current approach is to construct a unified merchant information platform and ensure that the information of the merchants accessed is accurate and complete. However, the following issues exist in the specific construction process:

On the merchant information platform where merchants register, there may be cases where merchant information and business information are mixed, and there are underreporting and misreporting during the information submission process. In addition, changes in business conditions, such as merchant relocation or closure, may lead to discrepancies between registered merchant information and the actual situation;

Merchant storefront photos uploaded by the merchants for accessing the network may be processed by Photoshop or may be forged; and

Merchant storefront photos uploaded by the merchants may not be consistent with the registered locations, and it is possible that they are not in the same area at all.

In consideration of the above issues, there is an urgent need for effective means for verifying merchant authenticity for data cleansing. Existing methods for verifying merchant authenticity include the verification method of manual inspection and verification, as well as the verification method of combining search engines and natural language processing technologies.

Among them, the verification method of manual inspection and verification for merchant verification offers the highest accuracy, but is inefficient, leading to high verification costs.

On the other hand, as for the method of combining search engines and natural language processing technologies for merchant authenticity verification, when searching for a merchant name by entering a certain address or longitude and latitude, it will return to the merchant names of multiple merchants around the location. In this case, there may also be certain problems, such as the inability to distinguish merchants with the same name in the same area, and the inability to verify merchant information when the merchant address is filled in incorrectly.

### SUMMARY

In view of the aforementioned issues, the present disclosure provides a merchant authenticity verification system and a merchant authenticity verification method based on street view image recognition, which operates without manual intervention and enhances accuracy.

A merchant authenticity verification method according to one aspect of the present disclosure is characterized in that the method verifies authenticity of a merchant based on merchant location, merchant name, merchant storefront image from a merchant information platform, and street view images from a street view image system. The method comprises the following steps:
calculating a translation scale based on a given reference image, where the translation scale is used to translate coordinates of an image acquisition point;
obtaining, based on merchant location information obtained from the merchant information platform, a first street view image corresponding to the merchant location information from the street view image system, and conducting a feature point matching between a merchant storefront image obtained from the merchant information platform and the first street view image and translating the first street view image along the road direction based on the translation scale to obtain the coordinates of the image acquisition point;
obtaining, based on the coordinates of the image acquisition point, a second street view image corresponding to the coordinates of the image acquisition point from the street view image system;
cropping a portion of image from the second street view image to obtain a third street view image;
conducting a feature point matching between the merchant storefront image obtained from the merchant information platform and the third street view image to calculate merchant image similarity, determining whether the merchant image similarity reaches a specified threshold, and proceeding with the following steps when it is determined that the merchant image similarity reaches the specified threshold; and
identifying a merchant name from the third street view image and matching it with the merchant name obtained from the merchant information platform to calculate merchant name similarity, and determining whether the merchant name similarity reaches a specified threshold, where in the case that the merchant name similarity reaches the specified threshold, merchant authenticity verification is successful.

A merchant authenticity verification system according to one aspect of the present disclosure is characterized in that the system verifies authenticity of a merchant based on merchant location, merchant name and merchant storefront image from a merchant information platform, and street view images from a street view image system. The system comprises:
a processing system; and
a memory storing instructions that, when executed by the processing system, cause the system to:
obtain merchant location, merchant name, and merchant storefront image from a merchant information platform, calculate a translation scale for translating coordinates of an image acquisition point, calculate the coordinates of the image acquisition point obtained by moving the street view image based on the translation scale, and interact with the street view image system to obtain a corresponding street view image based on the coordinates of the image acquisition point;
match a merchant storefront image obtained from the merchant information platform with the street view image obtained from the street view roaming module to calculate merchant image similarity, and determine whether the merchant image similarity reaches a specified threshold;
recognize a merchant name from the street view image obtained from the street view roaming module; and
match the merchant name recognized by the character recognition module with the merchant name obtained from the merchant information platform to calculate merchant name similarity, and determine whether the merchant name similarity reaches a specified threshold, where in the case that the merchant name similarity reaches the specified threshold, merchant authenticity verification is successful.

A computer-readable medium storing a computer program according to one aspect of the present disclosure is characterized in that the computer program, when executed by a processor, implements the aforementioned merchant authenticity verification method.

A computer device comprising a storage module, a processor, and a computer program stored in the storage module and runnable on a processor according to one aspect of the present disclosure is characterized in that the processor, when executing the computer program, implements the aforementioned merchant authenticity verification method.

A computer-readable medium storing a computer program according to the present disclosure is characterized in that the computer program, when executed by a processor, implements the aforementioned merchant authenticity verification method.

The computer device comprising a storage module, a processor, and a computer program stored in the storage module and runnable on a processor according to the present disclosure is characterized in that the processor, when executing the computer program, implements the aforementioned merchant authenticity verification method.

In view of the foregoing, the present disclosure provides a merchant authenticity verification system and a merchant authenticity verification method based on street view image recognition. Leveraging existing comprehensive street view image databases from companies like Baidu eliminates the need for creating a separate street view database. The combination of street view image roaming search and image comparison technology significantly improves the accuracy of merchant verification without manual intervention, thus saving labor costs.

### BRIEF DESCRIPTION OF THE DRAWINGS

FIG. 1 is a structural block diagram showing a merchant authenticity verification system of the present disclosure.

FIG. 2 is a flow diagram showing a merchant authenticity verification method of the present disclosure.

FIG. 3 is a schematic diagram showing the use of the SIFT feature matching algorithm.

### DETAILED DESCRIPTION

The following describes some of the multiple embodiments of the present disclosure, which is aimed at providing a basic understanding of the present disclosure. It is not intended to confirm the key or decisive elements of the present disclosure or limit the scope of protection.

For simplicity and illustrative purposes, exemplary embodiments are mainly referred to herein to describe the principles of the present disclosure. However, those skilled in the art would readily recognize that the same principles can be equivalently applied to all types of merchant authenticity verification systems and merchant authenticity verification methods based on street view image recognition, and these same principles can be implemented therein. Any such changes do not depart from the true spirit and scope of the present patent application.

In addition, in the following description, reference is made to figures, which illustrate specific exemplary embodiments. Without departing from the spirit and scope of the present disclosure, changes can be made to these embodiments in terms of electrical, mechanical, logical, and structural aspects. Furthermore, although a feature of the present disclosure is disclosed in conjunction with only one of several implementations/embodiments, if, however, it may be desired and/or advantageous for any given or recognizable function, this feature can be combined with one or more other features of other implementations/embodiments. Therefore, the following description should not be considered to be restrictive, and the scope of the present disclosure is defined by the appended claims and their equivalents.

Terms such as “comprise” and “include” indicate that, besides having units (modules) and steps directly and explicitly stated in the description and claims, the technical solution of the present disclosure does not exclude the scenario of having other units (modules) and steps that are not directly or explicitly stated.

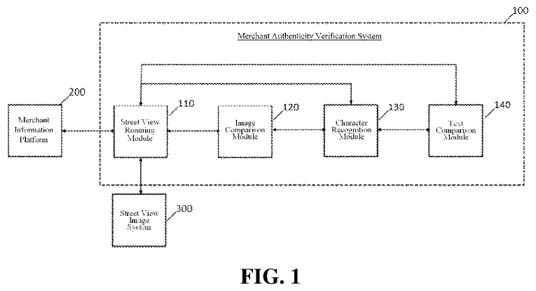

FIG. 1 is a structural block diagram showing a merchant authenticity verification system of the present disclosure.

As shown in FIG. 1, a merchant authenticity verification system 100 of the present disclosure verifies the authenticity of a merchant based on the merchant location, merchant name, merchant storefront image from a merchant information platform 200, and street view images from a street view image system 300.

The merchant authenticity verification system 100 of the present disclosure comprises:
a street view roaming module 110 that interacts with the street view image system 300, calculates the range of road coordinates, calculates the translation scale, moves data acquisition points along the road direction, and obtains street view image data;
an image comparison module 120 that matches using feature points and calculates image similarity;
a character recognition module 130 that recognizes the merchant name of the corresponding merchant in the street view image; and
a text comparison module 140 that matches the merchant name recognized by the character recognition module with the merchant name filled in by the merchant and calculates merchant name similarity.

Here, the merchant information platform 200 can provide information such as merchant location, merchant name, and merchant storefront image. The street view image system 300 can provide street view images of the corresponding positions based on the coordinates provided by the street view roaming module 110. The street view image system 300 can achieve this using existing technologies, such as the comprehensive street view image databases from companies like Baidu Maps and Gaode Maps, without the need to build a separate street view database.

As an example, it can be configured that when the image similarity obtained by the image comparison module 120 reaches a specified threshold, the merchant name similarity is then calculated by the text comparison module 140, and in the case where the text comparison module 140 calculates that the merchant name similarity reaches the specified threshold, it is determined that the merchant authenticity verification is successful.

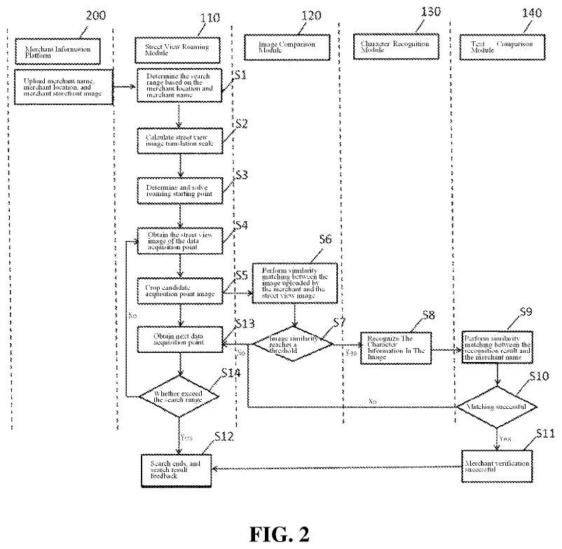

FIG. 2 is a flow diagram showing a merchant authenticity verification method of the present disclosure.

As shown in FIG. 2, the merchant authenticity verification method of the present disclosure mainly comprises the following steps:

Step S1: determining, by the street view roaming module 110, the search range based on the merchant location and merchant name obtained from the merchant information platform, wherein, the merchant information platform can provide information such as the merchant name, merchant location, and merchant storefront image uploaded by the merchant;

Step S2: calculating, by the street view roaming module 110, the translation scale based on the given reference image;

Step S3: obtaining, by the street view roaming module 110, the coordinates of the data acquisition point (starting point) for street view roaming based on the merchant storefront image F uploaded to the merchant information platform by the merchant and the street view image S, using a specified feature matching algorithm and based on the translation scale;

Step S4: obtaining, based on the coordinates of the data acquisition point (starting point), the corresponding street view image S1 from the street view image system 200;

Step S5: obtaining, using a specified feature matching algorithm, the coordinates of the matching point in the merchant storefront image F and the street view image S1, calculating the coordinates of the matching point as specified to obtain the calculated coordinates, and obtaining a cropped street view image S2 based on the calculated coordinates;

Step S6: matching, by the image comparison module 120, the merchant storefront image F uploaded by the user with the street view image S2 using feature points, and calculating merchant image similarity;

Step S7: determining, by the image comparison module 120, whether merchant image similarity reaches a specified threshold, where in the case that it reaches the specified threshold, proceed with step S8; otherwise, skip to step S13;

Step S8: recognizing, by the character recognition module 130, the merchant name from the street view image S2;

Step S9: matching, by the text comparison module 140, the merchant name recognized by the character recognition module 130 with the merchant name uploaded by the merchant, and calculating merchant name similarity;

Step S10: determining, by the text comparison module 140, whether the merchant name similarity reaches a specified threshold, where in the case that it reaches the specified threshold, proceed with step S11; and in the case that it does not reach the specified threshold, skip to step S13;

Step S11: merchant verification successful;

Step S12: search ends, return to search and verification results.

Step S13: obtaining, by the street view roaming module 110, the next data acquisition point;

Step S14: determining, by the street view roaming module 110, whether the next data acquisition point obtained exceeds the search range, where in the case that it does not exceed the search range, return to step S4; in the case it exceeds the search range, jump to step S12.

A specific embodiment of the merchant authenticity verification system and merchant authenticity verification method based on street view image recognition of the present disclosure will be explained below.

First, how the street view roaming module 110 obtains the search range is described.

The street view roaming module 110 retrieves merchant location and merchant name from the merchant information platform, where this information is uploaded by the merchant during registration. The street view roaming module 110, based on the location information registered by the merchant, obtains the latitude and longitude range (e.g., within approximately 1 kilometer of the merchant) and the merchant list C {(cxi, cyi)} corresponding to the location information.

Thus, the search range is obtained as: ((min (cxi), min (cyi)) to (max (cxi), max (cyi)).

Accordingly, the included angle t between the street and latitude lines is represented using the following equation:

$$t = arg tan ( ( mean ( cxi ) - min ( cxi ) ) / mean ( cyi ) - min ( cyi ) ) ) .$$

Next, the specific process of calculating the translation scale of the street view image by the street view roaming module 110 will be described.

In order to recognize the merchant storefront text in the street view using image and text recognition technologies, it is necessary to obtain a front merchant storefront image as much as possible by translating the longitude and latitude coordinates of the image acquisition point.

In actual street view images, due to great variations in street width and shooting distance, it is necessary to calculate the translation scale and the proportional scale between the pixel movement distance in the image and the actual movement distance for each street.

Two reference images I1 and I2 are provided, where the reference images I1 and I2 contain a calibration point A, the shooting position of the reference image I1 is (x1, y1), the shooting position of the reference image I2 is (x2, y2) (x2>x1) T, and the horizontal coordinates of A in the two images are p1 and p2 (p2-p1), respectively, then the translation scale is:

$$k = \sqrt{{( {x}_{1} - {x}_{2} )}^{2} + {( {y}_{1} - {y}_{2} )}^{2}} / ( {p}_{1} - {p}_{2} ) .$$

Wherein, two images containing common areas randomly selected from the street view images are used as the two reference images I1 and I2 as mentioned above, and the distance between the shooting positions of the two images is known.

Subsequently, the specific steps of how the street view roaming module 110 obtains the next candidate data acquisition point will be described:

The street view roaming module 110 obtains the next candidate data acquisition point through the following steps:
1) retrieving the merchant storefront image F and the street view image S from the merchant information platform, where the shooting position of the street view image S is (sx, sy), which is obtainable from the street view image system 300;
2) obtaining, using the SIFT feature matching algorithm, a matching feature point set P={p1, p2, . . . , pn} from the merchant storefront image F and the street view image S, where pi is the horizontal coordinate of the matching feature point;
3) calculating the mean value L of differences between the center position f of F and the respective values in P in the case that the number of feature points n in P is greater than a threshold m, and setting L as the minimum movement distance I in the case that n is less than m; and
4) setting the position of the next candidate acquisition point as N (sx+Lkcos (t), sy+kLsin (t)), where k is the translation scale, and t is the included angle between the street direction and longitude line.

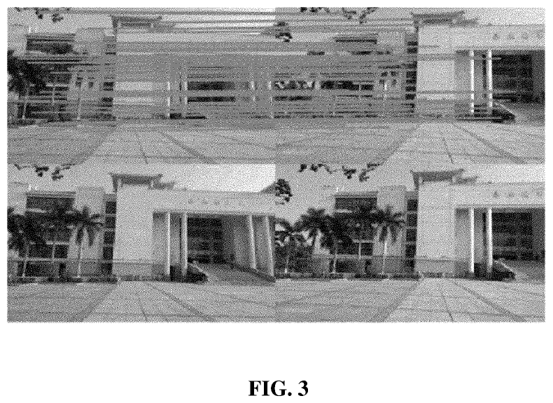

FIG. 3 is a schematic diagram showing the use of the SIFT feature matching algorithm. In FIG. 3, the left side is the merchant storefront image F, and the right side is the street view image S.

The SIFT feature matching algorithm is a scale-invariant feature transformation used to detect local features of an image, which searches for extreme points in spatial scale, extracting their position, scale, and rotation invariants. These key points are very prominent points, which will not change due to factors such as lighting and noise, such as corner points, edge points, bright spots in dark areas, and dark spots in bright areas. Therefore, they are independent of the size and rotation of the image, and have a high tolerance for changes in light, noise, and perspective.

SIFT is, theoretically speaking, a similarity invariant, which is invariant to image scale changes and rotations. However, due to the special processing of many details in constructing SIFT features, SIFT has strong adaptability to complex deformations and lighting changes in images. At the same time, the calculation speed is relatively fast and the positioning accuracy is relatively high. For example, detecting key points in multi-scale space using the DOG operator greatly accelerates the computational speed compared to the traditional detection method based on the LOG operator. The precise positioning of key points not only improves accuracy, but also greatly enhances the stability of key points.

In this embodiment, the SIFT feature matching algorithm is illustrated only as an example, and other image feature matching algorithms can also be used, such as SURF (Speeded Up Robust Feature) algorithm, SIFT (Scale Invariant Feature Transform) algorithm, ORB (ORiented Brief) algorithm, FAST (Features from Accelerated Segment Test) algorithm, Harris (Corner) algorithm, and so on.

The following describes how the street view roaming module 110 crops the image of the candidate acquisition point.

The street view roaming module 110 achieves cropping of the image of the candidate acquisition point through the following steps:
1) providing the merchant storefront image F uploaded by the merchant;
2) translating the data acquisition position to the candidate acquisition point position N, and obtaining the street view image S1 again from the street view image system 200;
3) obtaining, using the SIFT feature matching algorithm, a matching feature point set Q={(qx1, qy1), (qx2, qy2), . . . , (qxn, qyn)} from the merchant storefront image F and the street view image S1, where (qxi, qyi) is the horizontal and vertical coordinates of the matching feature point; and
4) cropping a portion of image from the street view image S1 to obtain a street view image S2, with the upper left and lower right coordinates {(min (qxi)-a, min (qyi)-a), (max (qxi)+a, max (qyi)+a)}, where a is the pixel distance with a value range of 10-100. In addition, the purpose of cropping the street view image S2 from the street view image S1 is to filter out redundant images other than key feature points, so as to prevent the occurrence of similarity matching between large and small images, thus improving the accuracy of image matching.

The image comparison module 120 matches the merchant storefront image F uploaded by the user with the street view image S2 using feature points, and calculates merchant image similarity. Here, the image similarity calculation method adopted by the image comparison module 120 can, for example, be existing matching method commonly used in computational vision, such as image grayscale-based matching method, feature-based matching method, model-based matching method, and transform domain-based matching method. As an example, reference can be specifically made to:

https:/wenku.baidu.com/view/019ec260657d27284b731242336c1eb91a37330f?fr=xueshu20001

The text comparison module 140 matches the merchant name recognized by the character recognition module 130 with the merchant name uploaded by the merchant, and calculates the merchant name similarity. Here, the merchant name similarity calculation method adopted by the text comparison module 140 can, for example, be existing text similarity calculation methods, such as string-based method, corpus-based method, and world knowledge-based method. As an example, reference can be specifically made to:

https://blog.csdn.net/gamer gvt/arti s/102916791.

As mentioned above, the present disclosure provides a merchant authenticity verification system and a merchant authenticity verification method based on street view image recognition. Leveraging existing comprehensive street view image databases from companies like Baidu Maps and Gaode Maps eliminates the need for creating a separate street view database. The combination of street view image roaming search and image comparison technology significantly improves the accuracy of merchant verification without manual intervention, thus saving labor costs.

The above examples mainly describe the merchant authenticity verification system and the merchant authenticity verification method based on street view image recognition according to the present disclosure. Although only some specific embodiments of the present disclosure have been described, those skilled in the art should be aware that the present disclosure may, without departing from its main idea and scope, be implemented in many other forms. Therefore, the examples and embodiments shown are considered illustrative rather than restrictive, and the present disclosure may cover various modifications and replacements without departing from the spirit and scope of the present disclosure as defined in the appended claim.

1. A merchant authenticity verification method, wherein the method verifies authenticity of a merchant based on merchant location, merchant name, merchant storefront image from a merchant information platform, and street view images from a street view image system, the method comprising following steps:
calculating a translation scale based on a given reference image, where the translation scale is used to translate coordinates of an image acquisition point;
obtaining, based on merchant location information obtained from the merchant information platform, a first street view image corresponding to the merchant location information from the street view image system, and conducting a feature point matching between the merchant storefront image obtained from the merchant information platform and the first street view image, and translating the first street view image along a road direction based on the translation scale to obtain coordinates of the image acquisition point;
obtaining, based on the coordinates of the image acquisition point, a second street view image corresponding to the coordinates of the image acquisition point from the street view image system;
cropping a portion of image from the second street view image to obtain a third street view image;
conducting a feature point matching between the merchant storefront image obtained from the merchant information platform and the third street view image to calculate merchant image similarity, and determining whether the merchant image similarity reaches a specified threshold, where in the case that it is determined that the merchant image similarity reaches the specified threshold, proceed with the following steps; and
recognizing a merchant name from the third street view image and matching it with the merchant name obtained from the merchant information platform to calculate merchant name similarity, and determining whether the merchant name similarity reaches a specified threshold, where in the case that the merchant name similarity reaches the specified threshold, merchant authenticity verification is successful.

2. The merchant authenticity verification method according to claim 1, wherein calculating a translation scale based on a given reference image comprises:
providing two reference images I1 and I2, where reference images I1 and I2 contain a calibration point A; and
in the case that shooting coordinates of reference image I1 are (x1, y1), shooting coordinates of reference image I2 are (x2, y2) (x2>x1), and horizontal coordinates of the calibration point A in the reference images I1 and I2 are p1 and p2 (p2-p1), respectively, the translation scale is:
$$k = \sqrt{{( {x}_{1} - {x}_{2} )}^{2} + {( {y}_{1} - {y}_{2} )}^{2}} / ( {p}_{1} - {p}_{2} ) .$$

3. The merchant authenticity verification method according to claim 2, wherein prior to calculating a translation scale based on a given reference image, the following step is further included:
obtaining, based on the merchant location information obtained from the merchant information platform, a search range of the image acquisition point corresponding to the merchant location information.

4. The merchant authenticity verification method according to claim 3, wherein prior to translating the first street view image along the road direction to obtain the coordinates of the image acquisition point, further determining whether the coordinates of the image acquisition point are within the search range of the image acquisition point, where in the case that it is determined to be within the search range of the image acquisition point, proceed with subsequent steps; otherwise, terminate the subsequent steps.

5. The merchant authenticity verification method according to claim 4, wherein obtaining the search range of the image acquisition point corresponding to the merchant location information comprises:
obtaining, based on the merchant location information obtained from the merchant information platform, latitude and longitude range and merchant list C {(cxi, cyi)} corresponding to the merchant location information obtained from the merchant information platform,
where the search range is represented as: (min (cxi), min (cyi)) to (max (cxi), max (cyi)).

6. The merchant authenticity verification method according to claim 5,
wherein conducting a feature point matching between the merchant storefront image obtained from the merchant information platform and the first street view image and translating the first street view image along the road direction based on the translation scale to obtain the coordinates of the image acquisition point, comprises:
setting shooting position of the first street view image to be (sx, sy);
obtaining, using a specified feature matching algorithm, a matching feature point set P={p1, p2, . . . , pn} from the merchant storefront image and the first street view image, where pi is the horizontal coordinate of the matching feature point;
calculating a mean value L of respective differences between a center position f of the merchant storefront image and the matching feature point set P in the case that the number of feature points n in the matching feature point set P is greater than a threshold m, and setting L as the minimum movement distance I in the case that n is less than the threshold m; and
setting coordinates of the image acquisition point as N, where N is (sx+Lkcos (t), sy+kLsin (t)),
wherein, k is the translation scale, and t is an included angle between street direction and longitude line,
where the included angle t is represented by the following equation:
$$t = arg tan ( ( mean ( cxi ) - min ( cxi ) ) / mean ( cyi ) - min ( cyi ) ) ) .$$

7. The merchant authenticity verification method according to claim 6, wherein the specified feature matching algorithm includes any of the following:
SIFT algorithm, SURF algorithm, SIFT algorithm, ORB algorithm, FAST algorithm, and Harri algorithm.

8. The merchant authenticity verification method according to claim 6, wherein cropping a portion of image from the second street view image to obtain a third street view image, comprises:
obtaining, using a specified feature matching algorithm, a matching feature point set Q={(qx1, qy1), (qx2, qy2), . . . , (qxn, qyn)} from the merchant storefront image and the second street view image, where (qxi, qyi) are horizontal and vertical coordinates of the matching feature point; and
cropping a portion of image from the second street view image to obtain the third street view image in the way so that upper left and lower right coordinates of the third street view image are: {(min (qxi)-a, min (qyi)-a), (max (qxi)+a, max (qyi)+a)}, where a is a pixel distance, with a value range of 10-100.

9. The merchant authenticity verification method according to claim 8, wherein the specified feature matching algorithm includes any of the following:
SIFT algorithm, SURF algorithm, SIFT algorithm, ORB algorithm, FAST algorithm, and Harri algorithm.

10. The merchant authenticity verification method according to claim 1, wherein calculating merchant image similarity employs any of the following matching methods:
image grayscale-based matching method, feature-based matching method, model-based matching method, and transform domain-based matching method.

11. The merchant authenticity verification method according to claim 1, wherein calculating merchant name similarity employs any of the following comparison methods:
string-based text similarity calculation method, corpus-based text similarity calculation method, and world knowledge-based text similarity calculation method.

12. A merchant authenticity verification system, wherein the system verifies authenticity of a merchant based on merchant location, merchant name and merchant storefront image from a merchant information platform, and street view images from a street view image system, the system comprising:
a processing system; and
a memory storing instructions that, when executed by the processing system, cause the system to:
obtain merchant location, merchant name, and merchant storefront image from the merchant information platform, calculate a translation scale for translating coordinates of an image acquisition point, and calculate the coordinates of the image acquisition point obtained by moving the street view image based on the translation scale, and interact with the street view image system to obtain a corresponding street view image based on the coordinates of the image acquisition point;
match the merchant storefront image obtained from the merchant information platform with the street view image obtained from the street view roaming module to calculate merchant image similarity, and determine whether the merchant image similarity reaches a specified threshold;
recognize a merchant name from the street view image obtained from the street view roaming module; and
match the merchant name recognized by the character recognition module with the merchant name obtained from the merchant information platform to calculate merchant name similarity, and determine whether the merchant name similarity reaches a specified threshold, where in the case that the merchant name similarity reaches the specified threshold, merchant authenticity verification is successful.

13. The merchant authenticity verification system according to claim 12, wherein execution of the instructions further causes the system to obtain merchant location, merchant name, and merchant storefront image from the merchant information platform, calculate the translation scale based on a given reference image, obtain the first street view image corresponding to the merchant location information from the street view image system based on the merchant location information obtained from the merchant information platform, translate the first street view image along the road direction to obtain the coordinates of the image acquisition point based on feature point matching between the merchant storefront image obtained from the merchant information platform and the first street view image as well as the translation scale, obtain the second street view image corresponding to the coordinates of the image acquisition point from the street view image system based on the coordinates of the image acquisition point, and crop a portion of image from the second street view image to obtain the third street view image;
match the merchant storefront image obtained from the merchant information platform with the third street view image obtained from the street view roaming module to calculate merchant image similarity; and
recognize the merchant name from the third street view image.

14. The merchant authenticity verification system according to claim 13, wherein calculating a translation scale based on a given reference image comprises:
providing two reference images I1 and I2, where reference images I1 and I2 contain a calibration point A;
in the case that shooting coordinates of reference image I1 are (x1, y1), shooting coordinates of reference image I2 are (x2, y2) (x2>x1), and horizontal coordinates of the calibration point A in the reference images I1 and I2 are p1 and p2 (p2-p1), respectively, the translation scale is:
$$k = \sqrt{{( {x}_{1} - {x}_{2} )}^{2} + {( {y}_{1} - {y}_{2} )}^{2}} / ( {p}_{1} - {p}_{2} ) .$$

15. The merchant authenticity verification system according to claim 14, wherein execution of the instructions further causes the system to obtain a search range of the image acquisition point corresponding to the merchant location information based on the merchant location information obtained from the merchant information platform.

16. The merchant authenticity verification system according to claim 15, wherein execution of the instructions further causes the system to prior to translating the first street view image along the road direction to obtain the coordinates of the image acquisition point, further determine whether the coordinates of the image acquisition point are within the search range of the image acquisition point, where in the case that it is determined to be within the search range of the image acquisition point, proceed with subsequent steps; otherwise, terminate the subsequent steps.

17. The merchant authenticity verification system according to claim 16, wherein obtaining the search range of the image acquisition point corresponding to the merchant location information comprises:
obtaining, based on the merchant location information obtained from the merchant information platform, latitude and longitude range and merchant list C {(cxi, cyi)} corresponding to the merchant location information from the merchant information platform,
where the search range is represented as: (min (cxi), min (cyi)) to (max (cxi), max (cyi)).

18. The merchant authenticity verification system according to claim 17,
wherein translating the first street view image along the road direction to obtain the coordinates of the image acquisition point based on the feature point matching between the merchant storefront image obtained from the merchant information platform and the first street view image as well as and the translation scale, comprises:
setting the shooting position of the first street view image to be (sx, sy);
obtaining, using a specified feature matching algorithm, a matching feature point set P={p1, p2, . . . , pn} from the merchant storefront image and the first street view image, where pi is the horizontal coordinate of the matching feature point;
calculating a mean value L of respective differences between the center position f of the merchant storefront image and the matching feature point set P in the case that the number of feature points n in the matching feature point set P is greater than a threshold m, and setting L as the minimum movement distance I in the case that n is less than the threshold m; and
setting coordinates of the image acquisition point as N, where N is (sx+Lkcos (t), sy+kLsin (t)),
wherein, k is the translation scale, and t is an included angle between the street direction and longitude line,
where the included angle t is represented by the following equation:
$$T = arg tan ( ( mean ( cxi ) - min ( cxi ) ) / mean ( cyi ) - min ( cyi ) ) )$$

19. The merchant authenticity verification system according to claim 18,
wherein the specified feature matching algorithm includes any of the following:
SIFT algorithm, SURF algorithm, SIFT algorithm, ORB algorithm, FAST algorithm, and Harri algorithm.

20. (canceled)

21. (canceled)

22. (canceled)

23. (canceled)

24. A computer-readable medium storing a computer program, wherein, the computer program, when executed by a processor, implements the merchant authenticity verification method according to any of claim 1.

25. (canceled)
